(19) United States
(12) Patent Application Publication
(10) Pub. No.: US 2005/0162558 A1
(43) Pub. Date: Jul. 28, 2005

(54) Multimedia authoring system

(76) Inventor: Johan Hendrik Antoon Gelissen, Eindhoven (NL)

Correspondence Address: U S Philips Corporation;Intellectual Property Department, P O Box 3001, Briarcliff Manor, NY, 10510, US

(21) Appl. No.: 10/498,955

(22) PCT Filed: Dec. 6, 2002
(86) PCT No.: PCT/IB02/05247

(30) Foreign Application Priority Data
Dec. 21, 2001 (EP) 01205143.9

(51) Int. Cl. H04N 5/14; H04N 5/781

(52) U.S. Cl. 348/576; 386/125

(57) ABSTRACT

A multimedia authoring system (100) includes a user interface (250) for receiving input from a user. A title generator (210) is used to generate a multimedia title under control of input of the user. A resource checker (220) includes a memory (240) for storing, for a predetermined rendering platform (140, 150) resource information on maximum capabilities of a plurality of rendering resources of the rendering platform. A resource monitor (230) in the resource checker receives from the title generator claims/releases on rendering resources by the title being generated. The resource monitor monitors for each of the rendering resources the claims made by the title. It provides an indication to the user if at least one claim on the rendering resources exceeds a maximum capability of a corresponding resource.

### FIELD OF THE INVENTION

The invention relates to a system and method for authoring of multimedia titles.

### BACKGROUND OF THE INVENTION

Multimedia titles, such as multimedia games and interactive Audio/Video (A/V) titles, are typically created for one, fully known rendering platform, such as a game machine of one set maker. The titles are extensively tested by teams of humans to verify that the various scene options allowed in the script do not exceed the resources of the rendering platform. Relevant resources are, for example, the memory, the main processor, graphics processors/accelerators, and I/O devices. A trend exists to release multimedia titles for more than one platform. Starting from the play script of the title released first a new release is created and tested for a second platform. This is a laborious task making the generation of multimedia titles expensive and time consuming.

In addition to the traditional game-oriented rendering platforms new platforms are appearing that focus more on rendering digital A/V titles. An important example of such a platform is the DVB/MHP platform (Digital Video Broadcasting/Multimedia Home Platform). There is also a trend to render A/V titles on portable devices, such as PDAs, and mobile telephones. Although nowadays many of such portable devices are still ‘closed’ systems in the sense that the manufacturer of the device does not allow third parties to develop software, including interactive multimedia titles, for the platform. However, a clear trend exists towards open platforms, based on open software machines, such as the Java virtual machine. For the DVB/MHP platform minimum requirements on the capabilities of the rendering platform have been defined. The minimum requirements actually define a ‘virtual’ rendering platform, since the platform can be implemented by several set makers independently based on different hardware and software but meeting certain minimum requirements, such as supporting a defined Java virtual machine, and being able to perform defined operations, within a defined time. Usually for the virtual rendering platform no reference is made to specific implementations, like instructions of a specific type of processor. The capabilities of the actual rendering platforms may exceed the minimum requirements.

### SUMMARY OF THE INVENTION

It is an object of the invention to enable the creation of multimedia titles without a need for extensive testing by humans. In particular, it is an object to enable creation of such titles for a virtual rendering platform as defined above.

To meet the object of the invention, a multimedia authoring system includes a user interface for receiving input from a user; a title generator for generating a multimedia title under control of input of the user; and a resource checker. The resource checker includes a memory and a resource monitor. The memory is used for storing, for a predetermined rendering platform, resource information on maximum capabilities of a plurality of rendering resources of the rendering platform. The resource monitor receives from the title generator claims/releases on rendering resources by the title being generated. The resource monitor monitors the claims/releases made by the title and provides an indication to the user if at least one claim on the rendering resources exceeds a maximum capability of a corresponding resource.

The title generator can be any conventional title creation system. According to the invention, claims/releases on the resources of the rendering platform for which the title is intended are monitored during the creation of the title. To this end, the system stores information on the maximum capabilities of resources of the rendering platform for which the title is intended. The human creator of the title, controlling the title generator, is alerted when claims on the resources exceed the maximum capabilities of the rendering platform. The creator can change the title accordingly, e.g. by lowering the quality of the audio/video (lower bit rate), or changing the script. In this way it is automatically ensured that the title being created can be reproduced by any rendering apparatus compliant with the rendering platform definitions, eliminating the need for extensive testing of each title by humans on each platform. This is particularly advantageous for open systems where the rendering platforms are independently developed by set makers to an agreed minimum set of requirements, such as is the case for DVB/MHP. In principle it is sufficient that the set makers checks that its own implementation of the platform indeed complies with the platform definitions, so that hardware and software platform implementations, such as the Java virtual machine, meet the agreed minimum requirements. The minimum requirements define the maximum capabilities of the rendering resources to be used by the title generated by the multimedia authoring system. Using the system according to the invention, multimedia titles can be generated for the agreed virtual reference platform without a need for testing on a physical reference platform, let alone all set maker specific implementations. The system is particularly suitable for development of titles for virtual platforms. It will be appreciated that the system can also be used for development of titles for actual hardware/software platforms. In the latter case, the minimum requirements of the platform are in fact the actual capabilities of the platform. Unless explicitly mentioned, in the remainder platform/apparatus refers to both a virtual platform/apparatus as well as an actual platform/apparatus. Examples of resources that can be monitored are usage of I/O devices, CPU load, and usage of the various type of memory and network bandwidth.

U.S. Pat. No. 6,226,785 describes an authoring tool that allows users of the tool to review the creation and evolution of a multimedia title that has been created with the tool. In particular, an end user of the tool can in this way determine how professional authors have created the title. This enables the end user to better modify the title. The tool has no provision for monitoring claim on the rendering platform. This tool can be used in combination with the system according to the invention.

U.S. Pat. No. 5,574,911 describes rendering of a multimedia title by the rendering platform. The platform includes a dynamic, run-time scheduler for efficient selection and allocation of resources to several multimedia objects, such as multiple multimedia titles being rendered simultaneously. This system may be used to render the multimedia title generated using the system according to the invention.

As defined in the dependent claim 2, the monitoring function is implemented by an agent, co-operating with the title generator. In this way, the conventional title generator can be left unmodified, with the only exception that the title generator needs to provide access to information on the claims/releases being made on the resources. The claim may be in an explicit form, such as number of bytes of memory. Alternatively, the claim can be in the form of supplying the script being developed in a graph representation, where the branches represent the various alternative scenes/dialogues, and the nodes represent the operations. The operations implicitly define the claims/releases on the resources. The agent translates the operation into explicit claims/releases on the respective resources of the rendering platform and monitors whether any of the branches results in operations exceeding the maximum capabilities of the (virtual) rendering platform. Preferably, the agent provides ‘intelligent’ indications to the user that the resources are exhausted or might get exhausted. For example, the agent may provide suggestions for adjusting the script (e.g. eliminating certain parallel operations exhausting the rendering platform), reducing the quality or bit-rate of A/V material, etc.

As defined in the dependent claim 3, the system stores resource information for more than one rendering platform. For each of the rendering platforms, the resource monitor checks the claims/releases on the resources of the rendering platform. The indication to the user is given if at least one of the resources of at least one of the rendering platforms is exhausted. In this way, the title can be generated for various rendering platforms in parallel, for instance for reproduction on a set top box, according to the DVB/MHP standard, or on a PDA. If the capabilities of a resource are exceeded, the designer of the title may choose to lower the demand made on the resource. Alternatively, the designer may choose to provide different titles for some of the platforms if it is not acceptable to perform the adjustment for all platforms. Using the system according to the invention, the designer can easily see when the demands are too high for a certain platform. Preferably, the system enables to designer to assign the rendering platforms to different groups, such as a highly capable group of rendering devices including, for example, PCs, set top boxes and game stations, and less capable devices, such as mobile phones and PDAs. As an example, the highly capable group may covers three (virtual) rendering platforms, such as a PC, a DVB/MHP set top box and a PlayStation 2 game station. The less capable group may cover two virtual platforms, such as Palm-based PDAs and a Nokia mobile phone platform. The designer can then choose to develop one title that can be rendered by all five platforms, to develop a separate title for each group, or even develop a separate tile for each platform. Monitoring can take place for each group or each platform independently.

As defined in the dependent claim 4, the resource monitor includes an agent for each (virtual) rendering platform. In this way independent monitoring for each platform can be implemented in a simple way, with minimal impact on the title creating tool.

As defined in the dependent claim 5, the system is operative to issue a pre-warning before the resource is actually exhausted. This enables the designer to take into account that for that part of the title no more substantial claims can be made on the title. Preferably, the designer can adjust the warning thresholds so that the pre-warnings are issued at a moment desired by the individual designer.

As defined in the dependent claim 6, tokens are used to represent the resources. A distinction is made between time independent and time dependent resources. Usage of time independent resources is regulated by claiming and releasing the resource. Resources of which only one is available may be modeled by one token. Examples of such resources are input devices, like keyboard, mouse and game controller. Such resources can be ‘allocated’ or ‘free’. Some time independent resources are preferably modeled by more than one token, where each token represents a part of the capabilities of the resource. Examples of such time independent resources are the main memory (typically volatile solid state memory) and background memory (where a further distinction may be made between various forms of permanent disc/tape based memory and non-volatile solid state memory). Examples of time dependent resources are the processor and bandwidth of the network and decoder. Such resources are modeled by token(s) per time unit. Tokens are claimed by the title generator and automatically released after expiry of the time unit.

To meet the object of the invention, a method of generating a multimedia title includes receiving input from a user; generating a multimedia title under control of input of the user; and during the generation, monitoring claims/releases made by the title being generated on a plurality of rendering resources of a predetermined rendering platform, comparing the claims/releases against maximum capabilities of the respective rendering resources of the rendering platform; and providing an indication to the user if at least one claim on the rendering resources exceeds a maximum capability of a corresponding resource. Also a computer program product can be supplied operative to cause a processor to perform the above described method. The computer program product may be distributed on a storage medium, such as an optical CD or a solid state memory.

These and other aspects of the invention are apparent from and will be elucidated with reference to the embodiments described hereinafter.

### BRIEF DESCRIPTION OF THE DRAWINGS

FIG. 1 shows a block diagram of a multimedia authoring and rendering system;

FIG. 2 illustrates the authoring system according to the invention;

FIG. 3 shows a structure of the memory storing resource information for several rendering platforms.

### DETAILED DESCRIPTION OF THE PREFERRED EMBODIMENT

In the remainder, multimedia title or multimedia content refers to the software product to be consumed by general audiences. The product is created/composed on an authoring system (combination of suitable hardware and software) from basic content such as text, graphics, sound, video, movies and animations. The title is rendered to the audience by a rendering apparatus, usually in an interactive environment. Typically the user can explore and revisit different sections of the multimedia title. The multimedia title may be designed so that as the user advances through the content of the products, the user navigates through the information possibly solving puzzles, demonstrating/testing knowledge or participating interactive simulations.

The development of a multimedia title is typically achieved through the (joined) efforts of skilled artists who produce the sounds, images, and animations, and skilled software authors who bind together the art, define the interactive relationships between the multimedia product and the user and codify the behavior of the simulations and games. Multimedia authors typically use an authoring system to create or modify a multimedia product. Generally, authoring systems provide a direct manipulation interface that allows authors to define the behavior of objects by writing a textual descriptions in a scripting language, or by rearranging graphic items in a flowchart.

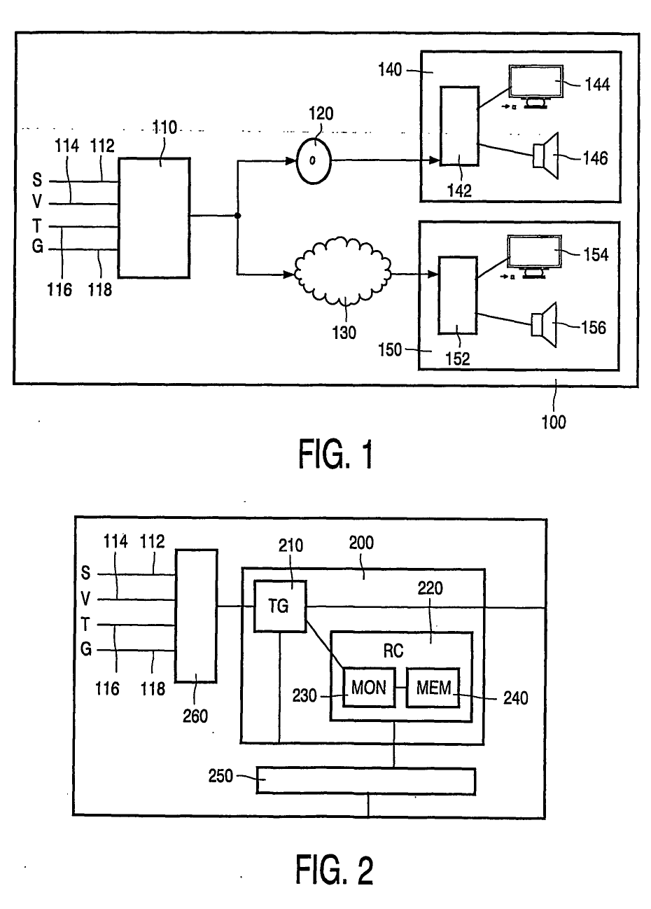

FIG. 1 shows a block diagram of a multimedia authoring and rendering system 100. The system includes an authoring system 110 and rendering apparatuses (shown are two rendering apparatuses 140 and 150). The authoring system 110 is typically implemented on an enhanced computer optimally equipped to handle analogue and/or digital audio/video as well as text, graphics data and animations. Usually, the authoring system is capable of encoding sounds and video to various quality levels. In itself the authoring system according to the invention can be implemented on existing hardware platforms currently used for authoring systems. The hardware of such a system is usually based on a conventional, albeit powerful, computer. As such, the hardware will usually include a processor, graphics processor/accelerator, main memory (e.g. RAM), background memory (e.g. hard disk and rewriteable optical disk), input devices, such as a keyboard, mouse, game controller, and output devices, such as a display and an audio subsystem with an audio board and speakers.

FIG. 1 shows an example wherein the authoring system receives sound 112, video 114, text 116 and graphics 118 as basic content. In this example, this basic content has been created outside the authoring system by artists. It will be appreciated that some or all of the basic content of a title may also be directly created using the authoring system 110. The title may be supplied to the rendering apparatuses in any suitable form. Shown are deliveries via a storage medium 120, such as a CD ROM, or via a network 130, like the Internet. In itself the authoring system according to the invention provides an improved way of producing multimedia titles. The title itself need not be different. As such, the title can be rendered on existing rendering apparatuses, such as PCs, DVB/MHP compliant set top boxes or TVs, game stations, etc, depending on the platform for which the title was designed. Typically the rendering apparatus 140, 150 includes a processing unit 142, 152 capable of reproducing the content of the title. The processing unit 142, 152 usually includes an A/V decoder. The rendering apparatus 140, 150 also includes a display 144, 154 and an audio subsystem 146, 156 including speakers.

FIG. 2 shows a block diagram of the main functional elements of the authoring tool 200 of the authoring system 110. The authoring tool refers to the additional software on the authoring computer used to create the multimedia title. The authoring tool 200 receives input from a user via a user interface 250, such as a keyboard, and mouse, and can supply feedback via the user interface 250, for example via a display. The tool 200 also has an interface 260 for receiving basic content such as sound 112, video 114, text 116 and graphics 118. A title generator 210 is operative to generate a multimedia title under control of input of the user. A resource checker 220 monitors claims/releases on resources of the rendering platform resulting from operation of the title being generated on the authoring system. To this end, the resource checker 220 includes a memory 240 for storing, for a predetermined type of rendering platform, resource information on maximum capabilities of a plurality of rendering resources of the rendering platform. It will be appreciated that preferably the information represents the capabilities of a virtual rendering platform, whereas an actual rendering apparatus implementing the virtual rendering platform may actually have more resources. The memory 240 may be a part of the memory of the authoring system 110 that also stores the software for operating the system and the authoring tool. The resource checker also includes a resource monitor 230. The resource monitor 230 receives from the title generator 210 claims/releases on rendering resources in an interactive manner while the title is being created. It will be appreciated that the claims represent claims that will be made by the title on resources of a compliant rendering apparatus when the title is actually being rendered. The resource monitor is operative to monitor for each of the rendering resources the claims/releases made by the title and to provide an indication to the user if at least one claim on the rendering resources exceeds a maximum capability of a corresponding resource.

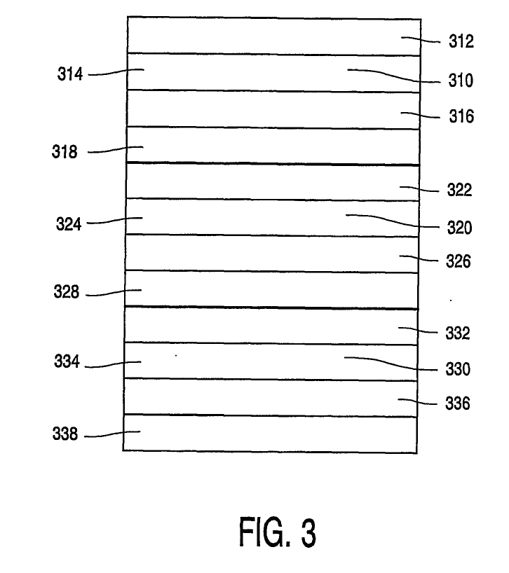

FIG. 3 illustrates a subdivision of the memory 240, where according to a preferred embodiment the memory 240 is operative to store for a predetermined plurality of rendering platforms respective rendering resource information. Shown is that resource information is stored for three different (virtual) rendering platforms in three respective parts 310, 320 and 330 of the memory 240. Each part can store information for a plurality of resources of the corresponding (virtual) rendering platform. As an example is shown that information is stored for three resources per type of rendering platform. The resource monitor is operative to perform the monitoring for each of the rendering platforms and provide the indication to the user if, for at least one of the rendering platforms, a claim on at least one of the resources exceeds the maximum capability. Preferably, the resource monitor performs the monitoring for each of the rendering platforms independent of each other in parallel (the parallel monitoring may be implemented sequentially using conventional time-slicing/task switching techniques).

Preferably, the resource monitor is implemented as an agent co-operating with the title generator for monitoring the claims/releases on the resources and providing the indication to the user. The title generator may be programmed to provide the required information to the agent. Preferably, the agent is programmed to autonomously retrieve relevant information on claiming/releasing of resources from data of the title generator. In this case, it may be necessary to modify the title generator to enable read access to data files used (opened) by the title generator. An example of relevant data is a script graph. In a system wherein the title can be generated for more than one type of (virtual) rendering platform at a time, preferably a separate agent is used for each (virtual) rendering platform type.

The title generator 210 indicates to the resource monitor 230 the claims/releases being made on the resources of the rendering platform. The claim may be in an explicit form, such as 1 Mbyte of graphics memory. Preferably, some or all of the claims are in the form of operations being required during rendering of the title, such as decoding a video stream in a certain format at a certain quality (e.g. frame rate and size) and performing a certain number of virtual instructions (e.g. Java instructions per second). The resource monitor 230 can then, using information stored in the memory 240, determine the actual claims being made on the resource(s) involved.

In a preferred embodiment, tokens are used to represent capabilities of a resource. For time independent resources, the capabilities are represented by a predetermined number of tokens. For time dependent resources, capabilities are represented by a predetermined number of tokens per time unit. For each time independent resource, the claims on a resource by the title generator are represented by a number of claimed tokens. The resource monitor is operative to monitor whether a total number of token claims exceeds a predetermined maximum number of tokens for the respective resource. The title generator explicitly claims and releases the time independent resources. The releasing may be implicit in the sense that, for example, the resource monitor from the script can detect that a certain operation starts and how long the operation lasts. The monitor can then from the start of the operation (which results in claims on resources) automatically determine when the resources will be released. For each time dependent resource, the claims on a resource by the title generator are represented by a number of claimed tokens per time unit. The resource monitor is operative to monitor whether for each time sequential time unit a total number of claims exceeds a predetermined maximum number of tokens for the respective resource. For time dependent resources, releasing of a resource is automatic as a consequence of expiry of the involved time unit.

It should be noted that the above-mentioned embodiments illustrate rather than limit the invention, and that those skilled in the art will be able to design many alternative embodiments without departing from the scope of the appended claims. For example,

In the claims, any reference signs placed between parenthesis shall not be construed as limiting the claim. The words “comprising” or “including” do not exclude the presence of other elements or steps than those listed in a claim. The invention can be implemented by means of hardware comprising several distinct elements, and by means of a computer suitably programmed to implement the method according to the invention. The program may be loaded permanently in the authoring system. The program may also be distributed in any suitable form, like on a storage medium such as a CD-ROM, or via a network such as Internet.

1. A multimedia authoring system (100) including:
a user interface (250) for receiving input from a user;
a title generator (210) for generating a multimedia title under control of input of the user; and
a resource checker (220) including:
a memory (240) for storing, for a predetermined rendering platform, resource information on maximum capabilities of a plurality of rendering resources of the rendering platform;
a resource monitor (230) for:
receiving from the title generator claims/releases on rendering resources by the title being generated,
monitoring for each of the rendering resources the claims made by the title; and
providing an indication to the user if at least one claim on the rendering resources exceeds a maximum capability of a corresponding resource.

2. The multimedia authoring system as claimed in claim 1, wherein the resource monitor includes an agent co-operating with the title generator for monitoring the claims/releases on the resources and providing the indication to the user.

3. The multimedia authoring system as claimed in claim 1, wherein the memory is operative to store for a predetermined plurality of types of rendering platforms respective rendering resource information; and the resource monitor is operative to perform the monitoring for each of the rendering platform types and provide the indication to the user if for at least one of the rendering platform types a claim on at least one of the resources exceeds the maximum capability.

4. The multimedia authoring system as claimed in claim 2, wherein the resource monitor includes for each of the plurality of rendering platform types a respective agent co-operating with the title generator for monitoring the claims/releases on the rendering resources of the respective rendering platform type and providing the indication to the user.

5. The multimedia authoring system as claimed in claim 1, wherein the resource monitor is operative to provide an indication to the user if least one claim on the rendering resources exceeds a predetermined part of the maximum capability of the corresponding resource.

6. The multimedia authoring system as claimed in claim 1, wherein capabilities of a time independent resource are represented by a predetermined number of tokens and capabilities of a time dependent resource are represented by a predetermined number of tokens per time unit;
for each time independent resource, the claims on a resource by the title generator are represented by a number of claimed tokens and the resource monitor being operative to monitor whether a total number of token claims exceeds a predetermined maximum number of tokens for the respective resource;
for each time dependent resource, the claims on a resource by the title generator are represented by a number of claimed tokens per time unit and the resource monitor being operative to monitor whether for each time sequential time unit a total number of claims exceeds a predetermined maximum number of tokens for the respective resource.

7. A method of generating a multimedia title including:
receiving input from a user;
generating a multimedia title under control of input of the user; and
during the generation, monitoring claims/releases made by the title being generated on a plurality of rendering resources of a predetermined rendering platform,
comparing the claims/releases against maximum capabilities of the respective rendering resources of the rendering platform; and
providing an indication to the user if at least one claim on the rendering resources exceeds a maximum capability of a corresponding resource.

8. A computer program product operative to cause a processor to perform the method as claimed in claim 7.

9. A storage medium including the computer program product as claimed in claim 8.
